(19) United States
(12) Patent Application Publication
(10) Pub. No.: US 2026/0195913 A1
(43) Pub. Date: Jul. 9, 2026

(54) TRAILER CHARACTERISTICS IDENTIFICATION USING PORTABLE DEVICE AND OVERLAY GRAPHICS

(71) Applicant: TOYOTA MOTOR ENGINEERING & MANUFACTURING NORTH AMERICA, INC., Plano, TX (US)

(72) Inventors: Vladimeros Vladimerou, Whitmore Lake, MI (US); Saijian Li, Bethesda, MD (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 19/009,499

(22) Filed: Jan. 3, 2025

(51) Int. Cl. G06T 7/60; G06T 7/13; G06V 10/70; G06V 20/58

(52) U.S. Cl. CPC G06T 7/60; G06T 7/13; G06V 10/70; G06V 20/58; G06T 2207/20092; G06T 2207/30261

(57) ABSTRACT

Systems and methods of the present disclosure provide solutions of performing trailer dimensions estimation. In an application, a method of performing trailer dimensions estimation is performed by a mobile terminal and includes receiving an image via a camera. The method includes displaying the received image on a screen of the mobile terminal. The method includes generating an outline of the vehicle and an outline of the trailer in the image. The method includes resizing the vehicle outline and the trailer outline to overlay the vehicle and trailer in the image. The method includes using the resized outlines to determine the dimensions of the vehicle and the trailer. The method includes using the dimensions of the vehicle and trailer to identify the vehicle and trailer in the image. The method includes storing the dimensions of the vehicle and trailer in a database according to the identification of the vehicle and trailer.

The present disclosure relates generally to the field of vehicle systems, and more particularly, some aspects of the systems and methods described herein relate to a method and system for object dimensions estimation for advanced driver support of trailer towing.

### BACKGROUND

Vehicles may be used as a means of transportation for the public. Vehicles may include automobiles, trucks, motorcycles, bicycles, scooters, mopeds, recreational vehicles and other like on-or off-road vehicles. Vehicles may further include autonomous, semi-autonomous and manually operated vehicles. As useful as vehicles are for the transportation of individuals, vehicles are also useful for the transportation of objects. Vehicles may transport objects both internally, i.e., objects stored within the interior space and trunk of the vehicle, and externally, i.e., towing objects stored on or in a trailer.

A vehicle may tow a trailer by connecting the trailer to the back of the vehicle using various parts, including for example a hitch and a trailer coupler. To support drivers in trailer towing, a vehicle system, such as an advanced driver assistance system (ADAS), may be used to align and connect the trailer to the vehicle, and accurately maneuver the trailer when the vehicle is being operated. Vehicle systems may support trailer towing by using trailer parameters, such as trailer dimensions, trailer axle location, etc. However, current vehicle systems may only obtain trailer parameters through manual entry or identification via onboard sensors while the vehicle is being driven with the trailer in tow.

### BRIEF SUMMARY OF THE DISCLOSURE

According to various aspects of the disclosed technology, systems and methods for object dimensions estimation are provided.

In accordance with some implementations, a method for object dimensions estimation is provided. The method may include: receiving an image of a vehicle and trailer from a camera; displaying the image on a screen; generating a vehicle outline and trailer outline based on the image; resizing the vehicle outline and trailer outline to overlay the vehicle and trailer in the image; and determining dimensions of the trailer based on the resized vehicle outline and resized trailer outline.

In some applications, the method may be performed by a mobile terminal that may include the camera.

In some applications, the mobile terminal may include the screen.

In some applications, the image may further include a hitch and trailer axle.

In some applications, the trailer outline may include a hitch outline and trailer axle outline.

In some applications, the resizing the trailer outline may include resizing hitch outline and trailer axle outline to overlay the hitch and trailer axle in the image.

In some applications, the determining the dimensions of the trailer may include determining hitch dimensions and trailer axle dimensions based on the resized vehicle outline, resized trailer outline, resized hitch outline and resized trailer axle outline.

In some applications, the method may further include: receiving vehicle data and trailer data corresponding to the vehicle and trailer in the image.

In some applications, the vehicle data and trailer data may be obtained from a sensor of the vehicle.

In some applications, the determining the dimensions may be further based on the vehicle data and trailer data.

In some applications, the method may further include: storing the dimensions in a database according to the vehicle data and trailer data.

In another aspect, a system for object dimensions estimation is provided that may include one or more processors; and memory coupled to the one or more processors to store instructions, which when executed by the one or more processors, may cause the one or more processors to perform operations. The operations may include: receiving an image of a vehicle and trailer from a camera; displaying the image on a screen; generating a vehicle outline and trailer outline based on the image; resizing the vehicle outline and trailer outline to overlay the vehicle and trailer in the image; and determining dimensions of the vehicle and trailer based on the resized vehicle outline and resized trailer outline.

In some applications, the method may be performed by a mobile terminal that may include the camera.

In some applications, the mobile terminal may include the screen.

In some applications, the image may further include a hitch and trailer axle.

In some applications, the vehicle outline may include a hitch outline and the trailer outline may include a trailer axle outline.

In some applications, the resizing the vehicle outline and trailer outline may include resizing hitch outline and trailer axle outline to overlay the hitch and trailer axle in the image.

In some applications, the determining the dimensions of the vehicle and trailer may include determining hitch dimensions and trailer axle dimensions based on the resized hitch outline and resized trailer axle outline.

In some applications, the system may further include operations comprising: receiving vehicle data and trailer data corresponding to the vehicle and trailer in the image.

In some applications, the vehicle data and trailer data may be obtained from a sensor of the vehicle.

In some applications, the determining the dimensions may be further based on the vehicle data and trailer data.

In some applications, the system may further include operations comprising: storing the dimensions in a database according to the vehicle data and trailer data.

In another aspect, a non-transitory machine-readable medium is provided. The non-transitory computer-readable medium may include instructions that when executed by a processor may cause the processor to perform operations including: receiving an image of a vehicle and trailer from a camera; displaying the image on a screen; generating a vehicle outline and trailer outline based on the image; resizing the vehicle outline and trailer outline to overlay the vehicle and trailer in the image; and determining dimensions of the vehicle and trailer based on the resized vehicle outline and resized trailer outline.

In some applications, the method may be performed by a mobile terminal that may include the camera.

In some applications, the mobile terminal may include the screen.

In some applications, the image may further include a hitch and trailer axle.

In some applications, the vehicle outline may include a hitch outline and the trailer outline may include a trailer axle outline.

In some applications, the resizing the vehicle outline and trailer outline may include resizing hitch outline and trailer axle outline to overlay the hitch and trailer axle in the image.

In some applications, the determining the dimensions of the vehicle and trailer may include determining hitch dimensions and trailer axle dimensions based on the resized hitch outline and resized trailer axle outline.

In some applications, the non-transitory machine-readable medium may further include operations comprising: receiving vehicle data and trailer data corresponding to the vehicle and trailer in the image.

In some applications, the vehicle data and trailer data may be obtained from a sensor of the vehicle.

In some applications, the determining the dimensions may be further based on the vehicle data and trailer data.

In some applications, the non-transitory machine-readable medium may further include operations comprising: storing the dimensions in a database according to the vehicle data and trailer data.

Other features and aspects of the disclosed technology will become apparent from the following detailed description, taken in conjunction with the accompanying drawings, which illustrate, by way of example, the features in accordance with applications of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various applications, is described in detail with reference to the following figures. The figures are provided for purposes of illustration only and merely depict typical or example applications. These illustrative examples are mentioned not to limit or define the disclosure, but to provide examples to aid understanding thereof. Additional examples are discussed in the Detailed Description, and further description is provided there.

FIG. 1 illustrates an example computing system, within or otherwise associated with a mobile terminal, for performing object dimensions estimation.

FIG. 2 illustrates an example process for performing object dimensions estimation according to example applications described in the present disclosure.

FIG. 3 illustrates an example image and outline of a vehicle and trailer with which applications of the disclosed technology may be implemented according to example applications described in the present disclosure.

FIG. 4 illustrates an example image and outline of a vehicle and trailer with which applications of the disclosed technology may be implemented according to example applications described in the present disclosure.

FIG. 5 illustrates an example computing component that includes one or more hardware processors and machine-readable storage media storing a set of machine-readable/machine-executable instructions that, when executed, cause the one or more hardware processors to perform an illustrative method for performing object dimensions estimation, according to example applications described in the present disclosure.

FIG. 6 illustrates a block diagram of an example computer system in which example applications of the present disclosure may be implemented.

The figures are not exhaustive and do not limit the present disclosure to the precise form disclosed.

### DETAILED DESCRIPTION

As described above, vehicles may be used as a means of transportation for the public as well as for goods for commercial, governmental and personal uses. Vehicles may include automobiles, trucks, motorcycles, bicycles, scooters, mopeds, recreational vehicles and other like on-or off-road vehicles. Vehicles may further include autonomous, semi-autonomous and manually operated vehicles. While vehicles are useful for the transportation of individuals, vehicles are also useful for the transportation of objects. Vehicles may transport objects both internally, i.e., objects stored within the interior space and trunk of the vehicle, and externally, i.e., towing objects stored on or in a trailer.

To transport an object using a trailer, a vehicle may tow the trailer by connecting the trailer to the back of the vehicle using various parts, including a hitch and a trailer coupler. A vehicle system, such as an advanced driver assistance system (ADAS), may be used to support drivers in trailer towing by assisting in the alignment and interconnection of the vehicle and the trailer, and in the accurate maneuvering of the trailer when the vehicle is being operated. Vehicle systems may support trailer towing by using trailer parameters, such as trailer dimensions, trailer axle location, etc. However, current vehicle systems are not able to obtain trailer parameters through convenient and efficient means, which may cause issues with the effectiveness and performance of trailer towing.

Aspects of the technology disclosed herein may provide systems and methods configured to perform object dimensions estimation. A computing system may receive vehicle data and trailer data. The vehicle data may correspond to an ego vehicle, with the vehicle data including identification information on the ego vehicle, including, for example, the type, model, year, size, dimensions, weight, horsepower, turning radius, and other parameters of the vehicle. The trailer data may correspond to an ego trailer that is connected with or to be connected with the vehicle, with the trailer data including identification information on the ego trailer, including, for example, the type, model, year, size, dimensions, weight, number of axles, tire size, hitch type, and other parameters of the trailer.

The vehicle data and trailer data may be obtained by one or more sensors. The ego vehicle may include one or more sensors. The ego trailer may include one or more sensors. The sensors may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS). Data may be received by at least a sensor of the ego vehicle or a sensor of the ego trailer or both. At least one sensor of the ego vehicle and ego trailer may receive data, wherein the data may include information on the ego trailer and ego vehicle. Data received by a sensor of the ego trailer may be shared with the ego vehicle. Data received by a sensor of the ego vehicle may be shared with the ego trailer. Data may be received by the ego vehicle and ego trailer from a sensor of another vehicle or a sensor of an infrastructure element or a combination of any of the foregoing. Many variations are possible.

The vehicle data and trailer data may be obtained from one or more databases. Data on the vehicle and trailer may have been previously obtained and stored in at least one database for future use. The vehicle data corresponding to the ego vehicle may be determined and obtained from a database upon determining identification information of the ego vehicle. The trailer data corresponding to the ego trailer may be determined and obtained from a database upon determining identification information of the ego trailer. Identification information of the ego vehicle and ego trailer may be determined by being inputted by a user. Identification information of the ego vehicle and ego trailer may be determined by one or more sensors scanning the ego vehicle and ego trailer. Many variations are possible.

The computing system may receive, from a camera, an image. The camera may be a component of a mobile device. The mobile device may include one or more cameras. The camera(s) of the mobile device may include a front facing camera, rear facing camera and/or other camera(s). When a user of the mobile device wants to use the mobile device to take photos, the user may open a camera application in the mobile device. Upon opening the camera application, the user may select to use one of various cameras within the mobile device. In an example, the user may select to use the front facing camera. In another example, the user may select to use the rear facing camera.

Once a camera is selected, the mobile device may receive an image from the selected camera. The received image may represent and contain all of the objects seen in real-time that are in view of the selected camera's lens. Objects may include persons, animals, plants, structures, buildings, vehicles, and any other objects or items existing in the world. The image received from the camera may include a vehicle, trailer, hitch, and trailer axle. The vehicle and hitch in the image may correspond to the ego vehicle. The trailer and trailer axle in the image may correspond to the ego trailer.

The computing system may display the received image on a screen. The screen may be a component of the mobile device. The mobile device may include one or more screens. The screen may display various types of media, including photos, videos, games, and other media applications. The screen may be a touch screen. The screen may include digital buttons that allow interaction for a user of the mobile device. A user of the mobile device may interact with the screen to perform various functions provided in the mobile device.

The image received via the selected camera may be displayed on the screen. The displayed image may represent and show all of the objects seen in real-time that are in view of and received from the selected camera's lens. The displayed image may be a direct representation of the objects a person, such as the user, may see through their own eyes, but from the perspective of a selected camera's lens of the mobile device. The displayed image may allow the user to see and acknowledge the scene and objects that are in view of and directly received from the selected camera's lens. Objects may include persons, animals, plants, structures, buildings, vehicles, and any other objects or items existing in the world. The displayed image may change to directly reflect and represent the image received from the selected camera's view. The received and displayed image may represent the image that can be taken as a photo by the selected camera. The screen may display the received image of the ego vehicle, ego trailer, hitch and trailer axle.

Vertical lines may be generated and placed against any object displayed in the image on the screen. A vertical line placed against an object may be used to determine the image-frame length of the respective object. The vertical lines may be used to scale and measure various objects displayed in the image. For example, vertical lines may be generated and placed on various objects in the image, such as the wheel of the ego trailer, rear wheel of the ego vehicle, front wheel of the ego vehicle, hitch and trailer axle. Each vertical line on an object may be used to scale and measure the various objects in the image. For example, the vertical line for the wheel of the ego trailer may be used to scale and measure the trailer wheel, the vertical line for the rear wheel of the ego vehicle may be used to scale and measure the ego vehicle rear wheel, the vertical line for the front wheel of the ego vehicle may be used to scale and measure the ego vehicle front wheel, the vertical line for the hitch to scale and measure the hitch, and the vertical line for the trailer axle may be used to scale and measure the trailer axle. Each of the vertical lines of various objects may be determined using the determined dimensions of one or more other objects, such as a traffic sign, building, door, ego vehicle, another vehicle, ego trailer, wheel of the ego trailer, wheel of the ego vehicle, etc. Many variations are possible.

The computing system (which may be on the mobile device, on the ego vehicle, on the trailer, a cloud computing system or otherwise, or a combination of any of the foregoing) may generate outlines of the vehicle, trailer, hitch and trailer axle in the image. An outline for each object presented in an image may be generated. The outline of an object may be a sketch of the outer perimeter of the object as displayed in the image. The outline of an object may be a sketch of the outer physical attributes of the object as displayed in the image. The outline of an object may be representative of the dimensions of the object according to the outer perimeter and physical attributes of the object. The outlines of the ego vehicle, ego trailer, hitch and trailer axle in the image may be sketches of the outer perimeter and/or physical attributes of the ego vehicle, ego trailer, hitch and trailer axle as displayed in the image, and the outlines of the ego vehicle, ego trailer, hitch and trailer axle may represent the dimensions of the ego vehicle, ego trailer, hitch and trailer axle, respectively, according to the outer perimeter and physical attributes of the respective object. For example, the outline of the ego vehicle may be a sketch of the outer perimeter and physical attributes of the ego vehicle as displayed in the image, including the outer frame, wheels, tires, windows, doors, hood, trunk, headlights, brake lights, and bumpers of the ego vehicle as displayed in the image. The outline of the hitch may be a sketch of the outer perimeter and physical attributes of the hitch as displayed in the image. The outline of the wheel of the trailer may be a sketch of the outer perimeter and physical attributes of the wheel of the trailer as displayed in the image. The outline of the trailer may be a sketch of the outer perimeter and physical attributes of the trailer as displayed in the image.

The computing system may place the outlines of the vehicle, trailer, hitch and trailer axle over the image. After the outline of an object is generated, the outline may be placed on the image as displayed on the screen. The outline of an object may be placed over the object in the image. In one example, the outline of an object may be placed over the respective object in the image as displayed on the screen. In another example, a user may move an outline of an object to be placed over the respective object in the image as displayed on the screen. Many variations are possible.

For example, an outline of the ego vehicle may be placed over the ego vehicle in the image as displayed on the screen. An outline of the ego trailer may be placed over the ego trailer in the image as displayed on the screen. An outline of the hitch may be placed over the hitch in the image as displayed on the screen. An outline of the trailer axle may be placed over the trailer axle in the image as displayed on the screen.

The computing system may resize the outlines to match the size of the vehicle, trailer, hitch and trailer axle in the image. After the outline of an object is generated and placed over the respective object displayed in an image, the outline may be resized to match the size of the respective object in the image. The resized outline may overlay the respective object displayed in the image. The outline of an object may be resized by a user. The outline of an object may be resized automatically by the computing system. For example, the outline of the ego vehicle may be resized to match the size of the ego vehicle in the image. The resized outline of the ego vehicle may overlay the ego vehicle displayed in the image. The outline of the ego trailer may be resized to match the size of the ego trailer in the image. The resized outline of the ego trailer may overlay the ego trailer displayed in the image.

The computing system may determine a plurality of dimensions based on the resized outlines and vertical lines of various objects in the image. The determined dimensions of an object may include one or more characteristics of the object, such as, for example, an estimate of the length, width, height, diameter, and thickness of the object. Using one or more vertical lines of one or more objects along with the resized outlines of each object in the image, dimensions may be determined for each object. A vertical line of an object may include the scale of that respective object. The vertical line of the object may be used with the resized outline of the respective object to determine the dimensions of the respective object by using the scale from the vertical line against the resized outline. For example, the vertical line of the wheel of the ego trailer may be used to determine a scale of the wheel of the ego trailer. The scale from the vertical line of the wheel of the ego trailer may be used against the resized outline of the wheel of the ego trailer that overlays the wheel of the ego trailer displayed in the image to determine the dimensions of the wheel of the ego trailer. Using the determined dimensions of the an object based on the vertical line and resized outline of the respective object, such determined dimensions may be used to determine the dimensions of other objects based on their resized outlines in comparison to the resized outline of the respective object. For example, the computing system may generate vertical lines for the wheels of the ego vehicle to determine the scale of each wheel. The computing component may generate resized outlines for each wheel of the ego vehicle and use the vertical lines for the wheels to determine the dimensions of each wheel based on the determined scale. Using the dimensions and resized outline of a wheel of the ego vehicle along with the resized outline of the ego vehicle, the computing system may determine dimensions of the ego vehicle. Many variations are possible.

The computing system may determine the dimensions of an object by using known dimensions of an identified object in the image. For example, the resized outlines of the ego vehicle and the ego trailer may be used to determine the dimensions of the ego vehicle and the ego trailer. The computing system may determine the identity of the ego vehicle to determine its dimensions. For example, the computing system may determine the identity of the ego vehicle to be a X brand, Y model, and Z year of a vehicle that has dimensions including a length of 14.7 feet (ft), width of 5.1 ft, and height of 5.3 ft. The computing system may use the determined dimensions of the ego vehicle, the resized outline of the ego vehicle and the resized outline of the ego trailer to determine the dimensions of the ego trailer. For example, the computing system may scale the resized outline of the ego vehicle with the dimensions of the ego vehicle of a length of 14.7 feet (ft), width of 5.1 ft, and height of 5.3 ft, and compare the scaled resized outline of the ego vehicle against the resized outline of the ego trailer to determine the dimensions of the ego trailer to include a length of 14.1 ft, width of 6.1 ft, and height of 6.4 ft. Many variations are possible.

The dimensions of the ego trailer and ego vehicle, along with the resized outlines of the hitch and trailer axle, may be used to determine the dimensions of the hitch and trailer axle. For example, the computing system may scale the resized outlines of the ego vehicle and ego trailer with the determined dimensions of the ego vehicle and ego trailer, and compare the scaled resized outlines of the ego vehicle and ego trailer against the resized outlines of the hitch and trailer axle to determine the dimensions of the hitch to include a height of 10.7 inches (in) and the dimensions of the trailer axle to include a height of 10.2 in. Many variations are possible.

The determined dimensions for each object in the image may be used with a vehicle system, such as an ADAS, to support trailer towing. A vehicle system may use the dimensions of the ego vehicle and ego trailer to assist in the alignment and interconnection of the ego vehicle and the ego trailer. Having accurate alignment and interconnection between the ego vehicle and the ego trailer may increase the safety and efficiency in trailer towing. The vehicle system may use the dimensions of the ego vehicle and ego trailer to analyze and determine maneuverability of the ego vehicle and ego trailer during trailer towing, which may also enhance driver awareness and vehicle responsiveness with respect to other surrounding objects (i.e., other vehicles, other trailers, pedestrians, etc.) during trailer towing.

The computing system may store the dimensions in a database according to the vehicle data and trailer data. The determined dimensions for each object in the image may be stored in a database. The determined dimensions for each object may include one or more images of the respective object. As an example, the determined dimensions of the ego trailer may be stored in a database with at least a portion of the received image that displays the ego trailer. The determined dimensions for each object may include labels and identification information of the respective object. For example, the determined dimensions of the ego trailer may be stored in a database based on the identification information of the ego trailer.

Upon receiving new images and/or data of vehicles and trailers, when a vehicle and/or trailer is determined to have identification information that matches a vehicle and/or trailer saved in the database, the stored dimensions for the respective vehicle and/or trailer may be retrieved from the database. Dimensions of an object stored in a database may be retrieved when it is determined that a retrieved image and/or inputted data contains an object with identification information that is identical to the identification information of the object stored in the database. Previous steps to determine the dimensions of an object, such as the ego vehicle and ego trailer, may be performed if stored dimensions are received for the object upon a determination of identical identification information.

The stored dimensions of an object may be compared to the new determined dimensions of the object to determine accuracy of the dimensions. If the new determined dimensions match the stored dimensions, then the stored dimensions may be retained and validated for accuracy. If the new determined dimensions do not match the stored dimensions, then the stored dimensions may be replaced by the new determined dimensions. The new determined dimensions may include information of the discrepancies from the previously stored dimensions. If the new determined dimensions do not match the stored dimensions, then the new determined dimensions may be stored in the database along with the stored dimensions for the object. The database may store both sets of dimensions for the object with information of the reason for the discrepancies between the two sets of dimensions, such as, for example, repairs performed on the object, variations of parts used, etc.

In other applications, a determination of dimensions of an object may be performed based on one or more algorithms. The one or more algorithms may be pre-stored in a database. The one or more algorithms may include a plurality of equations and methods to determine dimensions of an object in an image. In other applications, the dimensions features of an object in an image may be determined based on Machine Learning (ML) and/or Artificial Intelligence (AI). ML and/or AI may be used to identify an object in an image according to previously obtained images of objects. If an object in an image matches a previously obtained image of an object, the ML and/or AI may use the dimensions features of the previously obtained image of the object. The more images of a particular object obtained, the more quickly the ML and/or AI may be able to identify matching objects in images and obtain the dimensions features of the object. The ML and/or AI may learn from previous sessions and previously obtained images of objects to more quickly and efficiently determine dimensions features when performing the object detection in images.

It should be noted that the terms “accurate,” “accurately,” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

Accordingly, the present application provides solutions that implement the object dimensions estimation feature on devices, such as mobile phones and tablets. Examples described herein implement a computing component within a mobile terminal or device that performs object dimensions estimation on one or more objects in an image obtained from a camera of a mobile terminal, under some conditions or scenarios. First, the computing component may receive an image of a vehicle and trailer from a camera of a mobile terminal. The computing component may display the image received on a screen of the mobile terminal for the user of the mobile terminal to see. The computing component may generate an outline of the vehicle and an outline of the trailer in the image. The computing component may also generate an outline of every other object in the image, irrespective of whether such objects are associated with the vehicle and trailer. The computing component may resize the vehicle outline and the trailer outline to overlay the vehicle and trailer in the image. The computing component may resize all other object outlines to overlay on the respective objects in the image. The computing component may use the resized outlines to determine the dimensions of the vehicle and the trailer.

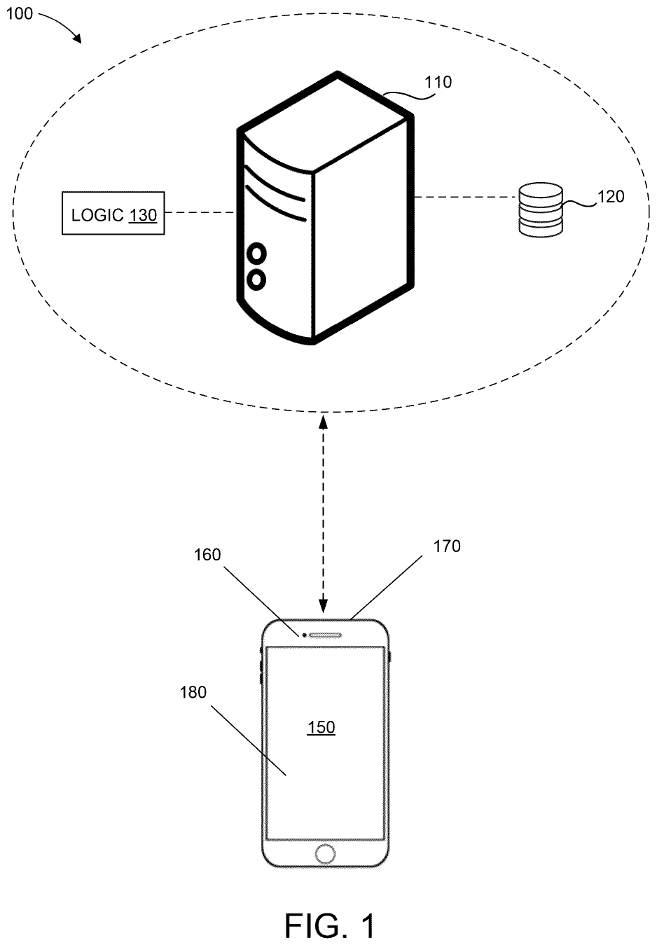

FIG. 1 illustrates an example of a computing system 100 which may be internal or otherwise associated with a device 150. In some applications, the computing system 100 may be a machine learning (ML) pipeline and model, and use ML algorithms. In some examples, the device 150 may include, but is not limited to, a mobile terminal including a laptop, smart phone, tablet or any mobile device equipped with at least one camera and at least one screen. The device 150 may include a front-facing camera 160 and/or a rear-facing camera 170. The device 150 may include a front-facing screen 180.

The device 150 may input data into computing component 110. The computing component 110 may perform one or more available operations on the input data to generate outputs, such as determining object dimensions estimations. The screen 180 may display the outputs as a two-dimensional (2D) and three dimensional (3D) image and layout, including an image and layout of a trailer with trailer dimensions.

The object dimensions may include, for example, a length, width, height, wheel diameter, tire thickness, and number of wheels of the trailer. The computing component 110 may include one or more hardware processors and logic 130 that implements instructions to carry out the functions of the computing component 110, for example, receiving an image of a vehicle and trailer from a camera; displaying the image on a screen; generating a vehicle outline and trailer outline based on the image; resizing the vehicle outline and trailer outline to overlay the vehicle and trailer in the image; and determining dimensions of the vehicle and trailer based on the resized vehicle outline and resized trailer outline. The computing component 110 may store, in a database 120, details regarding scenarios or conditions in which some object dimensions estimations are performed, algorithms, and images, layouts and outlines used to determine object dimensions of a trailer. Some of the scenarios or conditions will be illustrated in the subsequent FIGS.

A processor may include one or more GPUs, CPUs, microprocessors or any other suitable processing system. Each of the one or more processors may include one or more single core or multicore processors. The one or more processors may execute instructions stored in a non-transitory computer readable medium. Logic 130 may contain instructions (e.g., program logic) executable by the one or more processors to execute various functions of computing component 110. Logic 130 may contain additional instructions as well, including instructions to transmit data to, receive data from, and interact with device 150.

ML can refer to methods that, through the use of algorithms, are able to automatically extract intelligence or rules from training data sets and capture the same in informative models. In turn, those models are capable of making predictions based on patterns or inferences gleaned from subsequent data input into a trained model. According to implementations of the disclosed technology, the ML algorithm comprises, among other aspects, algorithms implementing a Gaussian process and the like. The ML algorithms disclosed herein may be supervised and unsupervised depending on the implementation. The ML algorithms may emulate the observed characteristics and components of vehicles, drivers and pedestrians to better evaluate and determine intervening obstacles to accurately perform countermeasures to prevent intervening obstacles from interfering between a set of vehicles in a hitchless towing configuration.

Although one example computing component 110 is illustrated in FIG. 1, in various applications multiple computing components 110 can be included. Additionally, one or more systems and subsystems of computing system 100 can include its own dedicated or shared computing component 110, or a variant thereof. Accordingly, although computing system 100 is illustrated as a discrete computing system, this is for ease of illustration only, and computing system 100 can be distributed among various systems or components.

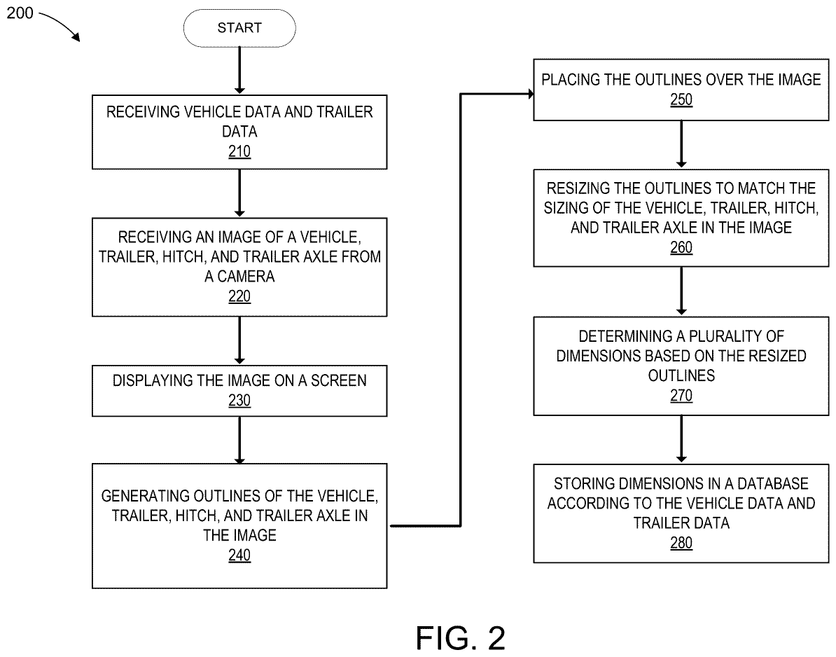

FIG. 2 illustrates an example scenario in which the computing component 110 may selectively perform object dimensions estimation. In some applications, the process 200 can be executed, for example, by the computing component 110 of FIG. 1. In other applications, the process 200 may be implemented as the computing component 110 of FIG. 1. The process 200 may include a server.

At block 210, the computing component 110 may receive vehicle data and trailer data. The vehicle data may correspond to an ego vehicle, with the vehicle data including identification information on the ego vehicle, including, for example, the type, model, year, size, dimensions, weight, and other parameters of the vehicle. The trailer data may correspond to an ego trailer that is interconnected with the vehicle, with the trailer data including identification information on the ego trailer, including, for example, the type, model, year, size, dimensions, weight, and other parameters of the trailer.

The vehicle data and trailer data may be obtained by one or more sensors. The ego vehicle may include one or more sensors. The ego trailer may include one or more sensors. The sensors may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS). Data may be received by at least a sensor of the ego vehicle or a sensor of the ego trailer. At least one sensor of the ego vehicle and ego trailer may receive data, wherein the data may include information on the ego trailer and ego vehicle. Data received by a sensor of the ego trailer may be shared with the ego vehicle. Data received by a sensor of the ego vehicle may be shared with the ego trailer. Data may be received by the ego vehicle and ego trailer from a sensor of another vehicle. Many variations are possible.

The vehicle data and trailer data may be obtained from one or more databases. Data on the vehicle and trailer may have been previously obtained and stored in at least one database for future use. The vehicle data corresponding to the ego vehicle may be determined and obtained from a database upon determining identification information of the ego vehicle. The trailer data corresponding to the ego trailer may be determined and obtained from a database upon determining identification information of the ego trailer. Identification information of the ego vehicle and ego trailer may be determined by being inputted by a user. Identification information of the ego vehicle and ego trailer may be determined by one or more sensors scanning the ego vehicle and ego trailer. Many variations are possible.

At block 220, the computing component 110 may receive, from a camera, an image. The camera may be a component of a mobile device, such as, for example, device 150. A device 150 may include one or more cameras. The camera(s) of a device 150 may include a front facing camera 160 and/or a rear facing camera 170. When a user of the device 150 wants to use the device 150 to take photos, the user may open a camera application in the device 150. Upon opening the camera application, the user may select to use one of various cameras within device 150. In an example, the user may select to use the front camera 160. In another example, the user may select to use the rear camera 170.

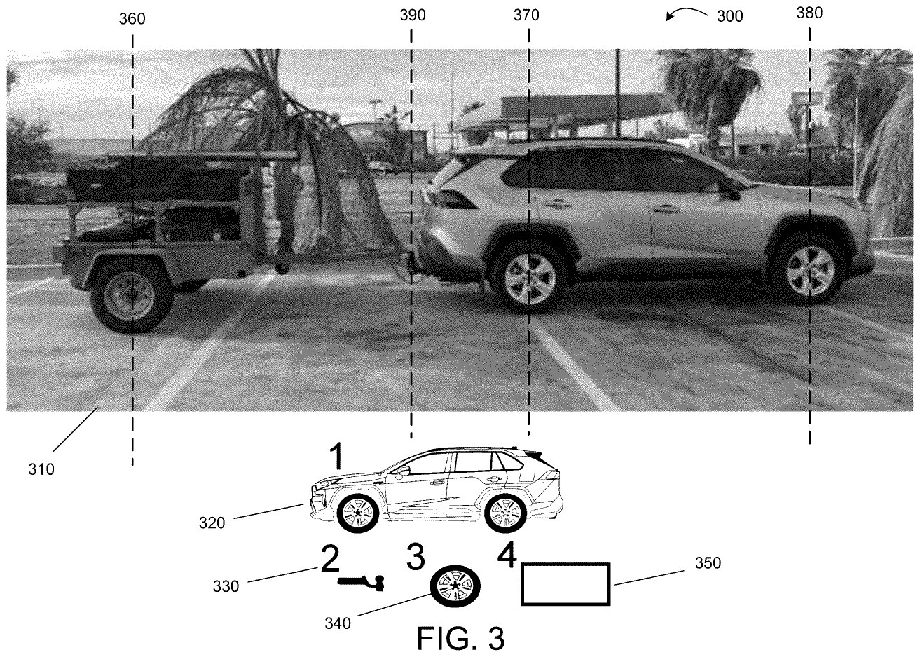

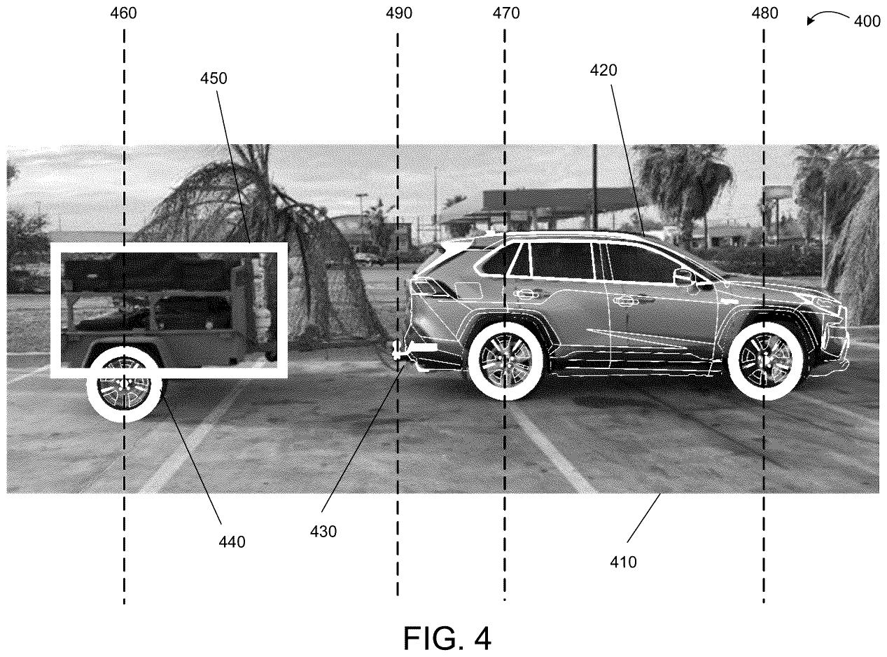

Once a camera is selected, the device 150 may receive an image from the selected camera. The received image may represent and contain all of the objects seen in real-time that are in view of the selected camera's lens. Objects may include persons, animals, plants, structures, buildings, vehicles, and any other objects or items existing in the world. The image received from the camera may include a vehicle, trailer, hitch, and trailer axle, such as, for example, image 310 of FIG. 3 and image 410 of FIG. 4. The vehicle and hitch in the image may correspond to the ego vehicle. The trailer and trailer axle in the image may correspond to the ego trailer.

At block 230, the computing component 110 may display the received image on a screen. The screen may be a component of a mobile device, such as, for example, device 150. The device 150 may include one or more screens, including screen 180. Screen 180 may display various types of media, including photos, videos, games, and other media applications. Screen 180 may be a touch screen. Screen 180 may include digital buttons that allow interaction for a user of device 150. A user of device 150 may interact with screen 180 to perform various functions provided in device 150.

The image received via the selected camera may be displayed on the screen 180. The displayed image may represent and show all of the objects seen in real-time that are in view of and received from the selected camera's lens. The displayed image may be a direct representation of the objects a person, such as the user, may see through their own eyes, but from the perspective of a selected camera's lens of device 150. The displayed image may allow the user to see and acknowledge the scene and objects that are in view of and directly received from the selected camera's lens. Objects may include persons, animals, plants, structures, buildings, vehicles, and any other objects or items existing in the world. The displayed image may change to directly reflect and represent the image received from the selected camera's view. The received and displayed image may represent the image that can be taken as a photo by the selected camera. The screen 180 may display the received image of the ego vehicle, ego trailer, hitch and trailer axle.

At block 240, the computing component 110 may generate outlines of the vehicle, trailer, hitch and trailer axle in the image. An outline for each object presented in an image may be generated. The outline of an object may be a sketch of the outer perimeter of the object as displayed in the image. The outline of an object may be a sketch of the outer physical attributes of the object as displayed in the image. The outlines of the ego vehicle, ego trailer, hitch and trailer axle in the image may be sketches of the outer perimeter and/or physical attributes of the ego vehicle, ego trailer, hitch and trailer axle as displayed in the image. For example, the outline of the ego vehicle may be a sketch of the outer perimeter and physical attributes of the ego vehicle as displayed in the image, including the outer frame, wheels, tires, windows, doors, hood, trunk, headlights, brake lights, and bumpers of the ego vehicle as displayed in the image, such as, for example, outline 320 of FIG. 3. The outline of the hitch may be a sketch of the outer perimeter and physical attributes of the hitch as displayed in the image, such as, for example, outline 330 of FIG. 3. The outline of the wheel of the trailer may be a sketch of the outer perimeter and physical attributes of the wheel of the trailer as displayed in the image, such as, for example, outline 340 of FIG. 3. The outline of the trailer may be a sketch of the outer perimeter and physical attributes of the trailer as displayed in the image, such as, for example, outline 350 of FIG. 3.

At block 250, the computing component 110 may place the outlines of the vehicle, trailer, hitch and trailer axle over the image. After the outline of an object is generated, the outline may be placed on the image as displayed on the screen. The outline of an object may be placed over the object in the image. In one example, the outline of an object may be placed over the respective object in the image as displayed on the screen. In another example, a user may move an outline of an object to be placed over the respective object in the image as displayed on the screen. Many variations are possible.

For example, an outline of the ego vehicle may be placed over the ego vehicle in the image as displayed on the screen. An outline of the ego trailer may be placed over the ego trailer in the image as displayed on the screen. An outline of the hitch may be placed over the hitch in the image as displayed on the screen. An outline of the trailer axle may be placed over the trailer axle in the image as displayed on the screen.

At block 260, the computing component 110 may resize the outlines to match the size of the vehicle, trailer, hitch and trailer axle in the image. After the outline of an object is generated and placed over the respective object displayed in an image, the outline may be resized to match the size of the respective object in the image. The resized outline may overlay the respective object displayed in the image. The outline of an object may be resized by a user. The outline of an object may be resized automatically by the computing component 110. For example, the outline of the ego vehicle may be resized to match the size of the ego vehicle in the image. The resized outline of the ego vehicle may overlay the ego vehicle displayed in the image, such as, for example, resized outline 420 of FIG. 4. The outline of the ego trailer may be resized to match the size of the ego trailer in the image. The resized outline of the ego trailer may overlay the ego trailer displayed in the image, such as, for example, resized outline 450 of FIG. 4.

At block 270, the computing component 110 may determine a plurality of dimensions based on the resized outlines. Using the resized outlines of each object in the image, dimensions may be determined for each object. The determined dimensions of an object may include one or more characteristics of the object, such as, for example, an estimate of the length, width, height, diameter, and thickness of the object. For example, the resized outlines of the ego vehicle and the ego trailer may be used to determine the dimensions of the ego vehicle and the ego trailer. To determine the dimensions of the ego vehicle, the computing component 110 may determine the identity of the ego vehicle. For example, the computing system 110 may determine the identity of the ego vehicle to be a X brand, Y model, and Z year of a vehicle that has dimensions to include a length of 15.2 feet (ft), width of 5.5 ft, and height of 5 ft. The computing system 110 may use the determined dimensions of the ego vehicle, the resized outline of the ego vehicle and the resized outline of the ego trailer to determine the dimensions of the ego trailer. For example, the computing system may scale the resized outline of the ego vehicle with the dimensions of the ego vehicle of a length of 15.2 feet (ft), width of 5.5 ft, and height of 5 ft, and compare the scaled resized outline of the ego vehicle against the resized outline of the ego trailer to determine the dimensions of the ego trailer to include a length of 13.7 ft, width of 6 ft, and height of 6 ft. The dimensions of the ego trailer and ego vehicle, along with the resized outlines of the hitch and trailer axle, may be used to determine the dimensions of the hitch and trailer axle. For example, the computing system 110 may scale the resized outlines of the ego vehicle and ego trailer with the determined dimensions of the ego vehicle and ego trailer, and compare the scaled resized outlines of the ego vehicle and ego trailer against the resized outlines of the hitch and trailer axle to determine the dimensions of the hitch to include a height of 10 inches (in) and the dimensions of the trailer axle to include a height of 10 in. Many variations are possible.

The determined dimensions for each object in the image may be used with a vehicle system, such as an ADAS, to support trailer towing. A vehicle system may use the dimensions of the ego vehicle and ego trailer to assist in the alignment and interconnection of the ego vehicle and the ego trailer. Having accurate alignment and interconnection between the ego vehicle and the ego trailer may increase the safety and efficiency in trailer towing. The vehicle system may use the dimensions of the ego vehicle and ego trailer to analyze and determine maneuverability of the ego vehicle and ego trailer during trailer towing, which may also enhance driver awareness and vehicle responsiveness with respect to other surrounding objects (i.e., other vehicles, other trailers, pedestrians, etc.) during trailer towing.

At block 280, the computing component 110 may store the dimensions in a database according to the vehicle data and trailer data. The determined dimensions for each object in the image may be stored in the database 120 of the computing component 110. The determined dimensions for each object may include one or more images of the respective object. As an example, the determined dimensions of the ego trailer may be stored in a database with at least a portion of the received image that displays the ego trailer. The determined dimensions for each object may include labels and identification information of the respective object. For example, the determined dimensions of the ego trailer may be stored in a database based on the identification information of the ego trailer.

Upon receiving new images and/or data of vehicles and trailers, when a vehicle and/or trailer is determined to have identification information that matches a vehicle and/or trailer saved in the database, the stored dimensions for the respective vehicle and/or trailer may be retrieved from the database. Dimensions of an object stored in a database may be retrieved when it is determined that a retrieved image and/or inputted data contains an object with identification information that is identical to the identification information of the object stored in the database. Blocks 230, 240, 250, 260, and 270 may be performed if stored dimensions are received for an object upon a determination of identical identification information.

The stored dimensions of an object may be compared to the new determined dimensions of the object to determine accuracy of the dimensions. If the new determined dimensions match the stored dimensions, then the stored dimensions may be retained and validated for accuracy. If the new determined dimensions do not match the stored dimensions, then the stored dimensions may be replaced by the new determined dimensions. The new determined dimensions may include information of the discrepancies from the previously stored dimensions. If the new determined dimensions do not match the stored dimensions, then the new determined dimensions may be stored in the database along with the stored dimensions for the object. The database may store both sets of dimensions for the object with information of the reason for the discrepancies between the two sets of dimensions, such as, for example, repairs performed on the object, variations of parts used, etc.

In other applications, a determination of dimensions of an object may be performed based on one or more algorithms. The one or more algorithms may be pre-stored in the database 120 of the computing component 110. The one or more algorithms may include a plurality of equations and methods to determine dimensions of an object in an image. In other applications, the dimensions features of an object in an image may be determined based on Machine Learning (ML) and/or Artificial Intelligence (AI). ML and/or AI may be used to identify an object in an image according to previously obtained images of objects. If an object in an image matches a previously obtained image of an object, the ML and/or AI may use the dimensions features of the previously obtained image of the object. The more images of a particular object obtained, the more quickly the ML and/or AI may be able to identify matching objects in images and obtain the dimensions features of the object. The ML and/or AI may learn from previous sessions and previously obtained images of objects to more quickly and efficiently determine dimensions features when performing the object detection in images.

FIG. 3 illustrates an example image of a vehicle and trailer and example outlines of the vehicle, trailer and other objects in the image in which a computing system may selectively perform object dimensions estimation. A computing system, such as, for example, object dimensions estimation system 300, may receive an image. The object dimensions estimation system 300 may be computing component 110 of FIG. 1. The image may be captured by camera. The camera may be a component of a mobile device, such as, for example, device 150 of FIG. 1. A mobile device may include one or more cameras. The camera(s) of a mobile device may include a front facing camera and/or a rear facing camera, such as, for example, front facing camera 160 and rear facing camera 170 of FIG. 1. When a user of the mobile device wants to use the mobile device to take photos, the user may open a camera application in the mobile device. Upon opening the camera application, the user may select to use one of various cameras within the mobile device. In an example, the user may select to use the front facing camera. In another example, the user may select to use the rear facing camera.

Once a camera is selected, the mobile device may receive an image from the selected camera. The received image may represent and contain all of the objects seen in real-time that are in view of the selected camera's lens. Objects may include persons, animals, plants, structures, buildings, vehicles, and any other objects or items existing in the world. The image received from the camera may include a vehicle, trailer, hitch, and trailer axle, such as, for example, image 310. The vehicle and hitch in the image may correspond to an ego vehicle. The trailer and trailer axle in the image may correspond to an ego trailer.

The object dimensions estimation system 300 may display the received image on a screen. The screen may be a component of a mobile device, such as, for example, device 150. The mobile device may include one or more screens, such as, for example, screen 180 of FIG. 1. The screen may display various types of media, including photos, videos, games, and other media applications. The screen may be a touch screen. The screen may include digital buttons that allow interaction for a user of the mobile device that includes the screen. A user of the mobile device that includes the screen may interact with the screen to perform various functions provided in the mobile device.

The image received via the selected camera may be displayed on the screen, as shown in image 310. The displayed image 310 may represent and show all of the objects seen in real-time that are in view of and received from the selected camera's lens. The displayed image may be a direct representation of the objects a person, such as the user, may see through their own eyes, but from the perspective of a selected camera's lens of the mobile device. The displayed image 310 may allow the user to see and acknowledge the scene and objects that are in view of and directly received from the selected camera's lens. Objects may include persons, animals, plants, structures, buildings, vehicles, and any other objects or items existing in the world. The displayed image 310 may change to directly reflect and represent the image received from the selected camera's view. The received and displayed image 310 may represent the image that can be taken as a photo by the selected camera. The screen may display the received image 310 of the vehicle, trailer, hitch and trailer axle.

The object dimensions estimation system 300 may generate outlines of the vehicle, trailer, and other objects displayed in the image 310. An outline for each object presented in an image may be generated. The outline of an object may be a sketch of the outer perimeter of the object as displayed in the image. The outline of an object may be a sketch of the outer physical attributes of the object as displayed in the image. The outlines of the vehicle, trailer, and other objects displayed in the image 310 may be sketches of the outer perimeter and/or physical attributes of the vehicle, trailer, and other objects.

For example, the outline of the vehicle, such as, for example, outline 320, may be a sketch of the outer perimeter and physical attributes of the vehicle as displayed in the image, including the outer frame, wheels, tires, windows, doors, hood, trunk, headlights, brake lights, and bumpers of the vehicle as displayed in the image. The outline of the hitch, such as, for example, outline 330, may be a sketch of the outer perimeter and physical attributes of the hitch as displayed in the image. The outline of the wheel of the trailer, such as, for example, outline 340, may be a sketch of the outer perimeter and physical attributes of the wheel of the trailer as displayed in the image. The outline of the trailer, such as, for example, outline 350, may be a sketch of the outer perimeter and physical attributes of the trailer as displayed in the image.

The object dimensions estimation system 300 may be used to generate and place vertical lines against any object displayed in the image 310 to determine the image-frame length of the respective object. The vertical lines may be used to scale and measure various objects displayed in the image 310. For example, the object dimensions estimation system 300 may generate and place the vertical lines 360, 370, 380 and 390 on various objects in the image 310, such as the trailer wheel, ego vehicle rear wheel, ego vehicle front wheel, hitch and trailer axle. Each vertical line 360, 370, 380 and 390 may be used to scale and measure the various objects in the image 310. The vertical line 360 may be used to scale and measure the trailer wheel, vertical line 370 to scale and measure the ego vehicle rear wheel, vertical line 380 to scale and measure the ego vehicle front wheel, and vertical line 390 to scale and measure the hitch and trailer axle. Each of the vertical lines 360, 370, 380, and 390 may be determined using the determined dimensions of one or more other objects, such as the ego vehicle, ego trailer, etc. Many variations are possible.

FIG. 4 illustrates an example image of a vehicle and trailer and example outlines of the vehicle, trailer and other objects in the image in which a computing system may selectively perform object dimensions estimation. A computing system, such as, for example, object dimensions estimation system 400, may be used to generate and place vertical lines against any object displayed in the image 410 to determine the image-frame length of the respective object. The object dimensions estimation system 400 may be computing component 110 of FIG. 1. The object dimensions estimation system 400 may be object dimensions estimation system 300 of FIG. 3. The vertical lines may be used to scale and measure various objects displayed in the image 410. For example, the object dimensions estimation system 400 may generate and place the vertical lines 460, 470, 480 and 490 on various objects in the image 410, such as the trailer wheel, vehicle rear wheel, vehicle front wheel, hitch and trailer axle. Each vertical line 460, 470, 480 and 490 may be used to scale and measure the various objects in the image 410. The vertical line 460 may be used to scale and measure the trailer wheel, vertical line 470 to scale and measure the vehicle rear wheel, vertical line 480 to scale and measure the vehicle front wheel, and vertical line 490 to scale and measure the hitch and trailer axle. Each of the vertical lines 460, 470, 480, and 490 may be determined using the determined dimensions of one or more other objects, such as the vehicle, trailer, etc. Many variations are possible.

The object dimensions estimation system 400, may generate outlines of the vehicle, trailer, hitch and trailer axle over the image. After the outline of an object is generated, as described in FIG. 2, the outline may be placed on the image as displayed on the screen. The outline of an object may be placed over the object in the image. In one example, the object dimensions estimation system 400 may place the outline of an object over the respective object in the image as displayed on the screen. In another example, a user may move an outline of an object to be placed over the respective object in the image as displayed on the screen. Many variations are possible.

For example, an image, such as, for example, image 410, may be displayed on a screen. The image 410 may include a vehicle, trailer, hitch and other objects associated with the vehicle and trailer, including wheels of the vehicle and trailer. An outline for each object presented in an image may be generated. The outline of an object may be a sketch of the outer perimeter of the object as displayed in the image. The outline of an object may be a sketch of the outer physical attributes of the object as displayed in the image. The outline of an object may be representative of the dimensions of the object according to the outer perimeter and physical attributes of the object. The outlines of the vehicle, trailer, hitch and trailer axle in the image may be sketches of the outer perimeter and/or physical attributes of the vehicle, trailer, hitch and trailer axle as displayed in the image, and the outlines of the vehicle, trailer, hitch and trailer axle may represent the dimensions of the vehicle, trailer, hitch and trailer axle, respectively, according to the outer perimeter and physical attributes of the respective object. For example, an outline of the vehicle may be generated and placed over the vehicle in the image 410. The outline of the vehicle may include the outer perimeter and physical attributes of the vehicle as displayed in the image, including the outer frame, wheels, tires, windows, doors, hood, trunk, headlights, brake lights, and bumpers of the vehicle as displayed in the image. An outline of the trailer may be generated and placed over the trailer in the image 410. The outline of the trailer may be a sketch of the outer perimeter and physical attributes of the trailer as displayed in the image. An outline of the hitch may be generated and placed over the hitch in the image 410. The outline of the hitch may be a sketch of the outer perimeter and physical attributes of the hitch as displayed in the image. An outline of the wheel of the trailer may be generated and placed over the wheel of the trailer in the image 410. The outline of the wheel of the trailer may be a sketch of the outer perimeter and physical attributes of the wheel of the trailer as displayed in the image.

After the outline of an object is generated and placed over the respective object displayed in an image, the outline may be resized to match the size of the respective object in the image. The resized outline may overlay the respective object displayed in the image. The object dimensions estimation system 400 may resize the outlines of the vehicle, trailer, hitch, and trailer wheel to match the size of the vehicle, trailer, hitch and trailer wheel as shown in the image 410. For example, the outline of the vehicle may be resized to match the size of the vehicle in the image. The resized outline of the vehicle, i.e., outline 420, may overlay the vehicle displayed in the image 410. The outline of the hitch may be resized to match the size of the hitch in the image 410. The resized outline of the hitch, i.e., outline 430, may overlay the hitch displayed in the image 410. The outline of the trailer wheel may be resized to match the size of the trailer wheel in the image 410. The resized outline of the trailer wheel, i.e., outline 440, may overlay the trailer wheel displayed in the image 410. The outline of the trailer may be resized to match the size of the trailer in the image 410. The resized outline of the trailer, i.e., outline 450, may overlay the trailer displayed in the image 410.

Using the resized outlines of each object and vertical lines of various objects in the image, the object dimensions estimation system 400 may determine dimensions for each object. The determined dimensions of an object may include one or more characteristics of the object, such as, for example, an estimate of the length, width, height, diameter, and thickness of the object. Using one or more vertical lines of one or more objects along with the resized outlines of each object in the image, dimensions may be determined for each object. A vertical line of an object may include the scale of that respective object. The vertical line of the object may be used with the resized outline of the respective object to determine the dimensions of the respective object by using the scale from the vertical line against the resized outline. For example, the vertical line 460 of the wheel of the trailer may be used to determine a scale of the wheel of the trailer. The scale from the vertical line 460 may be used against the resized outline 440 of the wheel of the trailer that overlays the wheel of the trailer displayed in the image 410 to determine the dimensions of the wheel of the trailer. Using the determined dimensions of the an object based on the vertical line and resized outline of the respective object, such determined dimensions may be used to determine the dimensions of other objects based on their resized outlines in comparison to the resized outline of the respective object. For example, the object dimensions estimation system 400 may generate vertical lines 470 and 480 for the wheels of the vehicle to determine the scale of each wheel. The object dimensions estimation system 400 may generate resized outlines for each wheel of the vehicle and use the vertical lines 470 and 480 to determine the dimensions of each wheel based on the determined scale. Using the dimensions and resized outline of a wheel of the vehicle along with the resized outline 420 of the vehicle, the object dimensions estimation system 400 may determine dimensions of the vehicle. Many variations are possible.

The object dimensions estimation system 400 may determine the dimensions of an object by using known dimensions of an identified object in the image. For example, the resized vehicle outline 420, resized hitch outline 430, resized trailer wheel outline 440, and resized trailer outline 450 may be used to determine the dimensions of the vehicle, trailer, hitch, and trailer wheel. The object dimensions estimation system 400 may determine the identity of one or more objects to determine the dimensions of the respective objects based on stored information on the respective objects. As an example, the object dimensions estimation system 400 may determine the identity of the trailer wheel to be an X type of wheel of Y brand that includes dimensions of a diameter of 25 in and width of 4 in. The object dimensions estimation system 400 may use the determined dimensions of the trailer wheel to scale the resized trailer wheel 440. The object dimensions estimation system 400 may compare the scaled resized trailer wheel outline 440 against the resized hitch outline 430 to determine the dimensions of the hitch to include a height of 9 inches (in). The dimensions of the hitch may be used to scale the resized hitch outline 430. The scaled resized hitch outline 430 and scaled resized trailer wheel outline 440, along with the resized vehicle outline 420 and resized trailer outline 450, may be used to determine the dimensions of the vehicle and trailer. The resized vehicle outline 420 may be compared with the scaled resized hitch outline 430 and scaled resized trailer wheel outline 440 to determine the dimensions of the vehicle to include a length of 16 feet (ft), width of 6.5 ft, and height of 5.7 ft. The resized trailer outline 450 may be compared with the scaled resized hitch outline 430 and scaled resized trailer wheel outline 440 to determine the dimensions of the trailer to include a length of 10.3 ft, width of 5.3 ft, and height of 4.6 ft. Many variations are possible.

The dimensions of the trailer and vehicle, along with the resized outline 430 of the hitch and trailer axle, may be used to determine the dimensions of the hitch and trailer axle. For example, the object dimensions estimation system 400 may scale the resized vehicle outline 420 and resized trailer outline 450 with the determined dimensions of the vehicle and trailer, and compare the scaled resized vehicle outline 420 and resized trailer outline 450 against the resized outline 430 of the hitch and trailer axle to determine the dimensions of the hitch to include a height of 10.7 inches (in) and the dimensions of the trailer axle to include a height of 10.2 in. Many variations are possible.

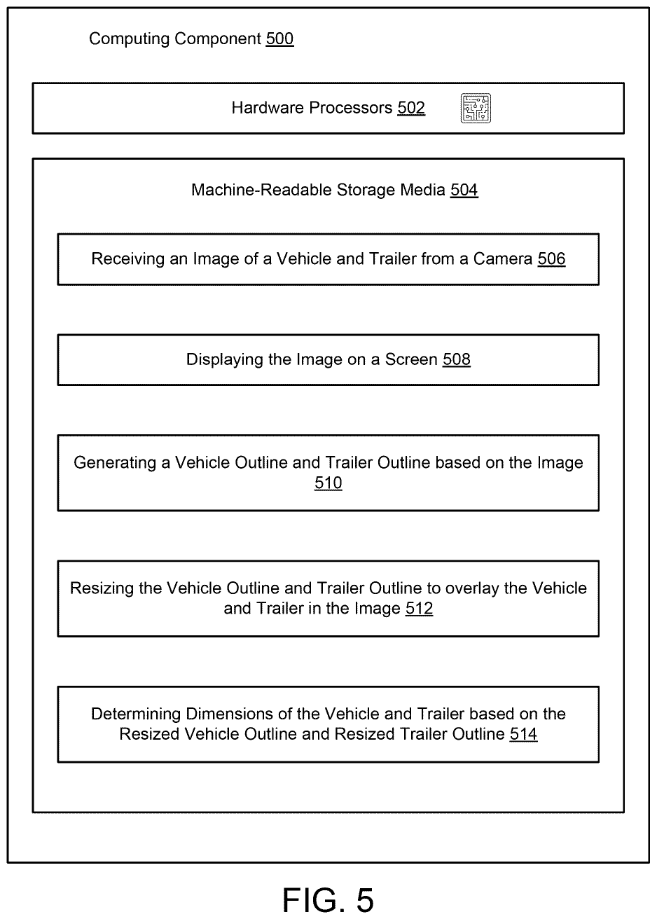

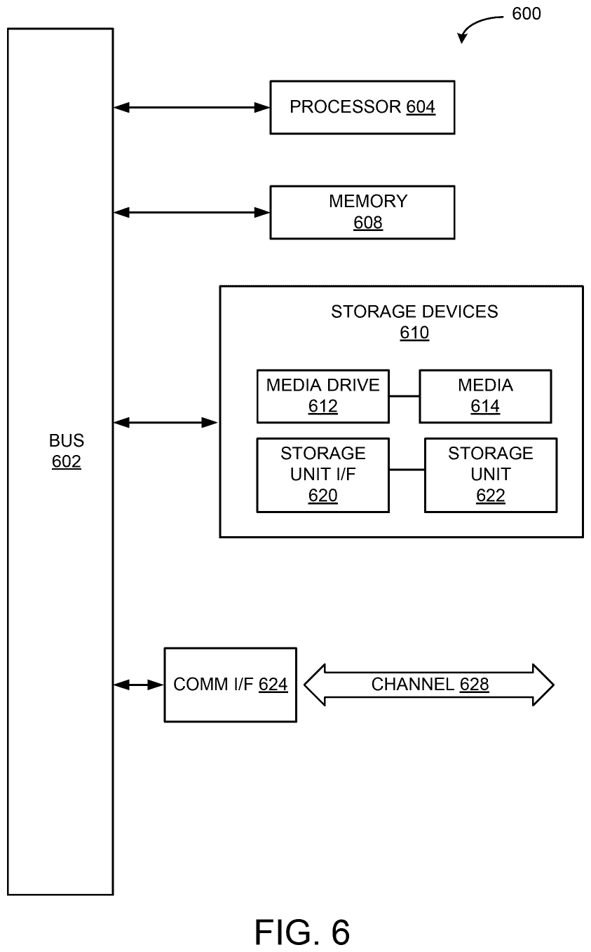

FIG. 5 illustrates a computing component 500 that includes one or more hardware processors 502 and machine-readable storage media 504 storing a set of machine-readable/machine-executable instructions that, when executed, cause the one or more hardware processors 502 to perform an illustrative method of performing object dimensions estimation, according to various applications of the present disclosure. It should be appreciated that there can be additional, fewer, or alternative steps performed in similar or alternative orders, or in parallel, within the scope of the various examples discussed herein unless otherwise stated. The computing component 500 may be implemented as the computing component 110 of FIG. 1, the object dimensions estimation system 200 of FIG. 2, and the object dimensions estimation system 300 of FIG. 3. The computing component 500 may include a server. The hardware processors 502 may include, for example, the processor(s) 604 of FIG. 6 or any other processing unit described herein. The machine-readable storage media 504 may include the main memory 608 of FIG. 6, the storage device 610 of FIG. 6, and/or any other suitable machine-readable storage media described herein.

At step 506, the hardware processor(s) 502 may execute the machine-readable/machine-executable instructions stored in the machine-readable storage media 504 to receive an image of a vehicle and trailer from a camera. The camera may be a component of a mobile terminal, such as, for example, device 150 of FIG. 1. A mobile terminal may include a laptop, smart phone, tablet or any mobile device equipped with at least one camera. A mobile terminal may include one or more cameras. The camera(s) of a mobile terminal may include a front facing camera, such as, for example, front facing camera 160 of FIG. 1, and/or a rear facing camera, such as, for example, rear facing camera 170 of FIG. 1. When a user of the mobile terminal wants to use the mobile terminal to take photos, the user may open a camera application in the mobile terminal. Upon opening the camera application, the user may select to use one of various cameras within mobile terminal. In an example, the user may select to use the front facing camera. In another example, the user may select to use the rear facing camera.

Once a camera is selected, the mobile terminal may receive an image from the selected camera. The received image may represent and contain all of the objects seen in real-time that are in view of the selected camera's lens. Objects may include persons, animals, plants, structures, buildings, vehicles, and any other objects or items existing in the world. The image received from the camera may include an ego vehicle and an ego trailer, such as, for example, image 210 of FIG. 2. The ego vehicle in the image may include components, such as, for example, the frame of the ego vehicle, the tires of the ego vehicle, and the hitch of the ego vehicle. The ego trailer in the image may include components, such as, for example, the frame of the ego trailer, the tires of the ego trailer, and the trailer axle of the ego trailer.

At step 508, the hardware processor(s) 502 may execute the machine-readable/machine-executable instructions stored in the machine-readable storage media 504 to display the image on a screen. The screen may be a component of a mobile terminal, i.e., device 150. A mobile terminal may include a laptop, smart phone, tablet, vehicle, or any mobile device equipped with at least one screen. The mobile terminal may include one or more screens, including screen 180 of FIG. 1. The screen may be a component of a different mobile terminal from the mobile terminal including the camera. The screen may display various types of media, including photos, videos, games, and other media applications. The screen may be a touch screen. The screen may include digital buttons that allow interaction for a user of the mobile terminal. A user of the mobile terminal may interact with the screen to perform various functions provided in the mobile terminal.

The image received via the selected camera may be displayed on the screen. The displayed image may represent and show all of the objects seen in real-time that are in view of and received from the selected camera's lens. The displayed image may be a direct representation of the objects a person, such as the user, may see through their own eyes, but from the perspective of a selected camera's lens of device 150. The displayed image may allow the user to see and acknowledge the scene and objects that are in view of and directly received from the selected camera's lens. Objects may include persons, animals, plants, structures, buildings, vehicles, and any other objects or items existing in the world. The displayed image may change to directly reflect and represent the image received from the selected camera's view. The received image that is displayed on the screen may represent the image that can be taken as a photo by the selected camera. The screen may display the received image of the ego vehicle and ego trailer.

Vertical lines may be generated and placed against any object displayed in the image on the screen. A vertical line placed against an object may be used to determine the image-frame length of the respective object. The vertical lines may be used to scale and measure various objects displayed in the image. For example, vertical lines may be generated and placed on various objects in the image, such as the wheel of the ego trailer, rear wheel of the ego vehicle, front wheel of the ego vehicle, hitch and trailer axle. Each vertical line on an object may be used to scale and measure the various objects in the image. For example, the vertical line for the wheel of the ego trailer may be used to scale and measure the trailer wheel, the vertical line for the rear wheel of the ego vehicle may be used to scale and measure the ego vehicle rear wheel, the vertical line for the front wheel of the ego vehicle may be used to scale and measure the ego vehicle front wheel, the vertical line for the hitch to scale and measure the hitch, and the vertical line for the trailer axle may be used to scale and measure the trailer axle. Each of the vertical lines of various objects may be determined using the determined dimensions of one or more other objects, such as a traffic sign, building, door, ego vehicle, another vehicle, ego trailer, wheel of the ego trailer, wheel of the ego vehicle, etc. Many variations are possible.

At step 510, the hardware processor(s) 502 may execute the machine-readable/machine-executable instructions stored in the machine-readable storage media 504 to generate a vehicle outline and trailer outline based on the image. An outline for each object presented in an image may be generated. The outline of an object may be a sketch of the outer perimeter of the object as displayed in the image. The outline of an object may be a sketch of the outer physical attributes of the object as displayed in the image. The outline of an object may be representative of the dimensions of the object according to the outer perimeter and physical attributes of the object. The outlines of the ego vehicle and ego trailer in the image may be sketches of the outer perimeter and/or physical attributes of the ego vehicle and ego trailer as displayed in the image, and the outlines of the ego vehicle and ego trailer may represent the dimensions of the ego vehicle and ego trailer, respectively, according to the outer perimeter and physical attributes of the respective object. The outlines of the ego vehicle may include outlines of each of the components of the ego vehicle, including, for example, an outline of the frame of the ego vehicle, an outline of each wheel of the ego vehicle, and an outline of the hitch of the ego vehicle, as displayed in the image. The outlines of the ego trailer may include outlines of each of the components of the ego trailer, including, for example, an outline of the frame of the ego trailer, an outline of each wheel of the ego trailer, and an outline of the trailer axle of the ego trailer, as displayed in the image.

For example, the outline of the ego vehicle may be a sketch of the outer perimeter and physical attributes of the ego vehicle as displayed in the image, including the outer frame, wheels, tires, windows, doors, hood, trunk, headlights, brake lights, and bumpers of the ego vehicle as displayed in the image, such as, for example, outline 220 of FIG. 2. The outline of the ego vehicle may also include an outline of the hitch, which may be a sketch of the outer perimeter and physical attributes of the hitch as displayed in the image, such as, for example, outline 230 of FIG. 2. The outline of the ego trailer may be a sketch of the outer perimeter and physical attributes of the ego trailer as displayed in the image, including the outer frame of the ego trailer, such as, for example, outline 250 of FIG. 2. The outline of the ego trailer may also include an outline of the wheel(s) of the ego trailer, which may be a sketch of the outer perimeter and physical attributes of the wheel(s) of the ego trailer as displayed in the image, such as, for example, outline 240 of FIG. 2.

At step 512, the hardware processor(s) 502 may execute the machine-readable/machine-executable instructions stored in the machine-readable storage media 504 to resize the vehicle outline and trailer outline to overlay the vehicle and trailer in the image. After generating an outline of an object in an image, the outline may be placed on the image as displayed on the screen. The outline of an object may be placed over the object in the image. In one example, the system may place the outline of an object over the respective object in the image as displayed on the screen. In another example, a user may move an outline of an object to be placed over the respective object in the image as displayed on the screen. The user may move the outline of an object my using a cursor on the screen. The cursor on the screen may be moved using a mouse, pen, finger, or any other object that may be used to point to and move an object on the screen. Many variations are possible.

For example, an outline of the ego vehicle may be moved and placed over the ego vehicle in the image as displayed on the screen. An outline of the each component of the ego vehicle, such as the frame, wheels and hitch of the ego vehicle, may be moved and placed over the corresponding component of the ego vehicle as displayed in the image on the screen. An outline of the ego trailer may be placed over the ego trailer in the image as displayed on the screen. An outline of the each component of the ego trailer, such as the frame, wheels and trailer axle of the ego trailer, may be moved and placed over the corresponding component of the ego trailer as displayed in the image on the screen.

After the outline of an object is generated and placed over the respective object displayed in an image, the outline may be resized to match the size of the respective object in the image. The resized outline may overlay the respective object displayed in the image. The outline of an object may be resized by a user, for example by pinching, expanding and dragging on a touchscreen display, or by other user input. The outline of an object may be resized automatically by a computing component, such as computing component 110 of FIG. 1. For example, the ego vehicle may be detected in the image and the outline of the ego vehicle may be resized to match the size of the ego vehicle in the image. The resized outline of the ego vehicle may be overlaid onto the ego vehicle displayed in the image, such as, for example, resized outline 320 of FIG. 3. The outline of the ego trailer may be resized to match the size of the ego trailer in the image using techniques similar to those described above with respect to the ego vehicle outline. The resized outline of the ego trailer may overlay the ego trailer displayed in the image, such as, for example, resized outline 350 of FIG. 3.

At step 514, the hardware processor(s) 502 may execute the machine-readable/machine-executable instructions stored in the machine-readable storage media 504 to determine dimensions of the vehicle and trailer based on the resized vehicle outline and resized trailer outline. The resized outlines of each object in the image may be used to determine dimensions for each object. The determined dimensions of an object may include one or more characteristics of the object, such as, for example, an estimate of the length, width, height, diameter, and thickness of the object.

Using one or more vertical lines of one or more objects along with the resized outlines of each object in the image, dimensions may be determined for each object. As previously discussed, a vertical line of an object may include the scale of that respective object. The vertical line of the object may be used with the resized outline of the respective object to determine the dimensions of the respective object by using the scale from the vertical line against the resized outline. For example, the vertical line of the wheel of the ego trailer may be used to determine a scale of the wheel of the ego trailer. The scale from the vertical line of the wheel of the ego trailer may be used against the resized outline of the wheel of the ego trailer that overlays the wheel of the ego trailer displayed in the image to determine the dimensions of the wheel of the ego trailer. Using the determined dimensions of the an object based on the vertical line and resized outline of the respective object, such determined dimensions may be used to determine the dimensions of other objects based on their resized outlines in comparison to the resized outline of the respective object. For example, the computing component 500 may generate vertical lines for the wheels of the ego vehicle to determine the scale of each wheel. The computing component may generate resized outlines for each wheel of the ego vehicle and use the vertical lines for the wheels to determine the dimensions of each wheel based on the determined scale. Using the dimensions and resized outline of a wheel of the ego vehicle along with the resized outline of the ego vehicle, the computing component 500 may determine dimensions of the ego vehicle. Many variations are possible.

The computing component 500 may determine the dimensions of an object by using known dimensions of an identified object in the image. For example, the resized outlines of the ego vehicle and the ego trailer may be used to determine the dimensions of the ego vehicle and the ego trailer. One or more objects in the image may be identified. Using the identity of an object, dimensions of the respective object may be determined from stored data. For example, the identity of the ego vehicle may be determined to be a X brand, Y model, and Z year of a vehicle that has dimensions including a length of 15.8 feet (ft), width of 6 ft, and height of 5.4 ft. The determined dimensions of the ego vehicle may be used to scale the resized outline of the ego vehicle. The scaled resized outline of the ego vehicle may be compared against the resized outline of the trailer to determine the dimension of the ego trailer to include a length of 12.9 ft, width of 5.6 ft, and height of 5.8 ft. The dimensions of the ego trailer may be used to scale the resized outline of the ego trailer. The scaled resized outline of the ego trailer and the scaled resized outline of the ego vehicle, along with the resized outlines of the hitch and trailer axle, may be used to determine the dimensions of the hitch and trailer axle. The dimensions of the hitch may be determined to include a height of 9 inches (in). The dimensions of the trailer axle may be determined to include a height of 8 in. Many variations are possible.

The determined dimensions for each object in the image may be used with a vehicle system, such as an ADAS, to support trailer towing. A vehicle system may use the dimensions of the ego vehicle and ego trailer to assist in the alignment and interconnection of the ego vehicle and the ego trailer. Having accurate alignment and interconnection between the ego vehicle and the ego trailer may increase the safety and efficiency in trailer towing. The vehicle system may use the dimensions of the ego vehicle and ego trailer to analyze and determine maneuverability of the ego vehicle and ego trailer during trailer towing and parking, which may also enhance driver awareness and vehicle responsiveness with respect to other surrounding objects (i.e., other vehicles, other trailers, pedestrians, etc.) during trailer towing.

Vehicle data and trailer data may be received, with the vehicle data corresponding to the ego vehicle and the trailer data corresponding to the ego trailer. The vehicle data may include identification information on the ego vehicle, including, for example, the type, model, year, size, dimensions, weight, and other parameters of the vehicle. The trailer data may include identification information on the ego trailer, including, for example, the type, model, year, size, dimensions, weight, and other parameters of the trailer.

The vehicle data and trailer data may be obtained by one or more sensors. The ego vehicle may include one or more sensors. The ego trailer may include one or more sensors. The sensors may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS). Data may be received by at least a sensor of the ego vehicle or a sensor of the ego trailer. At least one sensor of the ego vehicle and ego trailer may receive data, wherein the data may include information on the ego trailer and ego vehicle. Data received by a sensor of the ego trailer may be shared with the ego vehicle. Data received by a sensor of the ego vehicle may be shared with the ego trailer. Data may be received by the ego vehicle and ego trailer from a sensor of another vehicle. Many variations are possible.

The determined dimensions for each object in the image may be stored in a database, such as, for example, database 120 of the computing component 110 of FIG. 1. The determined dimensions for each object may include one or more images of the respective object. As an example, the determined dimensions of the ego trailer may be stored in a database with at least a portion of the received image that displays the ego trailer. The determined dimensions for each object may include labels and identification information of the respective object. For example, the determined dimensions of the ego trailer may be stored in a database based on the identification information of the ego trailer.

Upon receiving new images and/or data of vehicles and trailers, when a vehicle and/or trailer is determined to have identification information that matches a vehicle and/or trailer saved in the database, the stored dimensions for the respective vehicle and/or trailer may be retrieved from the database. Dimensions of an object stored in a database may be retrieved when it is determined that a retrieved image and/or inputted data contains an object with identification information that is identical to the identification information of the object stored in the database. Steps 508, 510, 512 and 514 may be performed if stored dimensions are received for an object, i.e., a vehicle and a trailer, upon a determination of identical identification information of the object.

The stored dimensions of an object may be compared to the new determined dimensions of the object to determine accuracy of the dimensions. If the new determined dimensions match the stored dimensions, then the stored dimensions may be retained and validated for accuracy. If the new determined dimensions do not match the stored dimensions, then the stored dimensions may be replaced by the new determined dimensions. The new determined dimensions may include information of the discrepancies from the previously stored dimensions. If the new determined dimensions do not match the stored dimensions, then the new determined dimensions may be stored in the database along with the stored dimensions for the object. The database may store both sets of dimensions for the object with information of the reason for the discrepancies between the two sets of dimensions, such as, for example, repairs performed on the object, variations of parts used, etc.

In other applications, a determination of dimensions of an object may be performed based on one or more algorithms. The one or more algorithms may be pre-stored in a database, such as, for example, database 120 of the computing component 110 of FIG. 1. The one or more algorithms may include a plurality of equations and methods to determine dimensions of an object in an image. In other applications, the dimensions features of an object in an image may be determined based on Machine Learning (ML) and/or Artificial Intelligence (AI). ML and/or AI may be used to identify an object in an image according to previously obtained images of objects. If an object in an image matches a previously obtained image of an object, the ML and/or AI may use the dimensions features of the previously obtained image of the object. The more images of a particular object obtained, the more quickly the ML and/or AI may be able to identify matching objects in images and obtain the dimensions features of the object. The ML and/or AI may learn from previous sessions and previously obtained images of objects to more quickly and efficiently determine dimensions features when performing the object detection in images.

FIG. 6 illustrates a block diagram of an example computer system 600 in which various applications of the present disclosure may be implemented. Component system 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing system 600 might also represent computing capabilities embedded within or otherwise available to a given device. For example, a computing system might be found in other electronic devices such as, for example, portable computing devices, and other electronic devices that might include some form of processing capability. In another example, a computing system might be found in components making up device 150, computing system 100, object dimensions estimation system 200, object dimensions estimation system 300, computing component 500, etc.

Computing system 600 might include, for example, one or more processors, controllers, control components, or other processing devices. This can include a processor, and/or any one or more of the components making up device 150 of FIG. 1, object dimensions estimation system 200 of FIG. 2, object dimensions estimation system 300 of FIG. 3, and computing component 500 of FIG. 5. Processor 604 might be implemented using a general-purpose or special-purpose processing engine such as, for example, a microprocessor, controller, or other control logic. The processor 604 might be specifically configured to execute one or more instructions for execution of logic of one or more circuits described herein. Processor 604 may be configured to execute one or more instructions for performing one or more methods, such as the method described in FIG. 5.

The computer system 600 can include a bus 602 for communicating information to one or more hardware processors 604 coupled with the bus 602 for processing information. However, any communication medium can be used to facilitate interaction with other components of computing system 600 or to communicate externally. In applications, processors 604 may fetch, decode, and execute one or more instructions to control processes and operations for determining object dimensions estimations as described herein. The hardware processor(s) 604 may be, for example, one or more general purpose microprocessors. The computer system 600 may be an application of a video encoding module, video decoding module, video encoder, video decoder, or similar device.

The computer system 600 can also include one or more memory components, such as main memory 608. Main memory 608 may be a random access memory (RAM), cache and/or other dynamic storage devices, coupled to the bus 602 for storing information and instructions to be executed by the hardware processor(s) 604. The main memory 608 may also be used for storing temporary variables or other intermediate information during execution of instructions by the hardware processor(s) 604. Such instructions, when stored in a storage media accessible to the hardware processor(s) 604, render the computer system 600 into a special-purpose machine that can be customized to perform the operations specified in the instructions. The computer system 600 can further include a read only memory (ROM) or other static storage device coupled to the bus 602 for storing static information and instructions for the hardware processor(s) 604.

The computing system 600 may also include one or more various forms of information storage mechanism 610, which may include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative applications, information storage mechanism 610 may include other similar instrumentalities for allowing computer programs or other instructions or data to be loaded into computing system 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing system 600.

Computing system 600 may also include a communications interface 624. Communications interface 624 might be used to allow software and data to be transferred between computing system 600 and external devices. Examples of communications interface 624 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

The computer system 600 may also include a network interface coupled to bus 602. The network interface may provide a two-way data communication coupling to one or more network links that are connected to one or more local networks. For example, the network interface may be an integrated services digital network (ISDN) card, cable modem, satellite modem, or a modem to provide a data communication connection to a corresponding type of telephone line. As another example, the network interface may be a local area network (LAN) card to provide a data communication connection to a compatible LAN (or WAN component to communicated with a WAN). Wireless links may also be implemented. In any such implementation, the network interface sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through the network interface, which carry the digital data to and from computer system 600, are example forms of transmission media.

The computer system 600 can send messages and receive data, including program code, through the network(s), network link and network interface. In the Internet example, a server might transmit a requested code for an application program through the Internet, the ISP, the local network and the network interface.

In this document, the terms “computer program medium” and “computer usable medium” are used to generally refer to transitory or non-transitory media. Such media may be, e.g., memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing system 600 to perform features or functions of the present application as discussed herein.

Aspects herein can be embodied in other forms without departing from the spirit or essential attributes thereof. Accordingly, reference should be made to the following claims, rather than to the foregoing specification, as indicating the scope hereof. While various applications of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various applications be implemented to perform the recited functionality in the same order, and with each of the steps shown, unless the context dictates otherwise.

It should be understood that the various features, aspects and functionality described in one or more of the individual applications are not limited in their applicability to the particular application with which they are described. Instead, they can be applied, alone or in various combinations, to one or more other applications, whether or not such applications are described and whether or not such features are presented as being a part of a described application. Thus, the breadth and scope of the present application should not be limited by any of the above-described exemplary applications.

In general, the word “component,” “modules,” “engine,” “system,” “database,” and the like, as used herein, can refer to logic embodied in hardware or firmware, or to a collection of software instructions, possibly having entry and exit points, written in a programming language, such as, for example, Java, C or C++. A software component or module may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices, such as the computing system 600, may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of an executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques or technology described herein using customized hard-wired logic, one or more ASICs or FPGAs, firmware and/or program logic which in combination with the computer system 600 that causes or programs the computer system 600 to be a special-purpose machine. According to one or more applications, the techniques described herein are performed by the computer system 600 in response to the hardware processor(s) 604 executing one or more sequences of one or more instructions contained in the main memory 608. Such instructions may be read into the main memory 608 from another storage medium, such as the storage device 610. Execution of the sequences of instructions contained in the main memory 608 can cause the hardware processor(s) 604 to perform process steps described herein. In alternative applications, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. The non-volatile media can include, for example, optical or magnetic disks, such as the storage device 610. The volatile media can include dynamic memory, such as the main memory 608. Common forms of the non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, an NVRAM, any other memory chip or cartridge, and networked versions of the same.

Non-transitory media is distinct from but may be used in conjunction with transmission media. The transmission media can participate in transferring information between the non-transitory media. For example, the transmission media can include coaxial cables, copper wire and fiber optics, including the wires that comprise the bus 602. The transmission media can also take a form of acoustic or light waves, such as those generated during radio-wave and infra-red data communications.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example applications. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality.

Where components are implemented in whole or in part using software, such software can be implemented to operate with a computing or processing system capable of carrying out the functionality described with respect thereto, such as computer system 600. One such example computing component is shown in FIG. 6. Various applications are described in terms of this example-computing system 600. After reading this description, it will become apparent to a person skilled in the relevant art how to implement the application using other computing components or architectures.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain applications include, while other applications do not include, certain features, elements and/or steps.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The term “operably connected,” “coupled”, or “coupled to”, as used throughout this description, can include direct or indirect connections, including connections without direct physical contact, electrical connections, optical connections, and so on. The terms “a” or “an” should be read as meaning “at least one,” “one or more” or the like. Adjectives such as “conventional,” “traditional,” “normal,” “standard,” “known” and terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various applications set forth herein are described in terms of exemplary block diagrams, flow charts and other illustrations. As will become apparent to one of ordinary skill in the art after reading this document, the illustrated applications and their various alternatives can be implemented without confinement to the illustrated examples. For example, block diagrams and their accompanying description should not be construed as mandating a particular architecture or configuration.

What is claimed is:

1. A computer-implemented method for trailer dimension estimation, the method comprising:
receiving an image of a vehicle and trailer from a camera;
displaying the image on a screen;
generating a vehicle outline and trailer outline based on the image;
resizing the vehicle outline and trailer outline to overlay the vehicle and trailer in the image; and
determining dimensions of the trailer based on the resized vehicle outline and resized trailer outline.

2. The computer-implemented method of claim 1, wherein the method is performed by a mobile terminal comprising the camera.

3. The computer-implemented method of claim 2, wherein the mobile terminal comprises the screen.

4. The computer-implemented method of claim 1, wherein the image further comprises a hitch and trailer axle.

5. The computer-implemented method of claim 4, wherein the trailer outline comprises a hitch outline and trailer axle outline.

6. The computer-implemented method of claim 5, wherein the resizing the trailer outline comprises resizing the hitch outline and trailer axle outline to overlay the hitch and trailer axle in the image.

7. The computer-implemented method of claim 6, wherein the determining the dimensions of the trailer comprises determining hitch dimensions and trailer axle dimensions based on the resized vehicle outline, resized trailer outline, resized hitch outline and resized trailer axle outline.

8. The computer-implemented method of claim 1, further comprising receiving vehicle data and trailer data corresponding to the vehicle and trailer in the image.

9. The computer-implemented method of claim 8, wherein the vehicle data and trailer data are obtained from a sensor of the vehicle.

10. The computer-implemented method of claim 8, wherein the determining the dimensions is further based on the vehicle data and trailer data.

11. The computer-implemented method of claim 8, further comprising storing the dimensions in a database according to the vehicle data and trailer data.

12. A computing system within or associated with a mobile terminal, the computing system comprising:
one or more processors; and
a memory storing instructions that, when executed by the one or more processors, cause the one or more processors to:
receive an image of a vehicle and trailer from a camera;
display the image on a screen;
generate a vehicle outline and trailer outline based on the image;
resize the vehicle outline and trailer outline to overlay the vehicle and trailer in the image; and
determine dimensions of the trailer based on the resized vehicle outline and resized trailer outline.

13. The computing system of claim 12, wherein the image further comprises a hitch and trailer axle.

14. The computing system of claim 13, wherein the trailer outline comprises a hitch outline and trailer axle outline.

15. The computing system of claim 14, wherein the resizing the vehicle outline and trailer outline comprises resizing the hitch outline and trailer axle outline to overlay the hitch and trailer axle in the image.

16. The computing system of claim 15, wherein the determining the dimensions of the trailer comprises determining hitch dimensions and trailer axle dimensions based on the resized vehicle outline, resized trailer outline, resized hitch outline and resized trailer axle outline.

17. The computing system of claim 12, further comprising receiving vehicle data and trailer data corresponding to the vehicle and trailer in the image.

18. The computing system of claim 17, wherein the determining the dimensions is further based on the vehicle data and trailer data.

19. The computing system of claim 17, further comprising storing the dimensions in a database according to the vehicle data and trailer data.

20. A non-transitory storage medium storing instructions that, when executed by at least one processor of a computing system, cause the computing system to perform a method comprising:
receiving an image of a vehicle and trailer from a camera;
displaying the image on a screen;
generating a vehicle outline and trailer outline based on the image;
resizing the vehicle outline and trailer outline to overlay the vehicle and trailer in the image; and
determining dimensions of the trailer based on the resized vehicle outline and resized trailer outline.
